(19) United States
(12) Patent Application Publication
(10) Pub. No.: US 2008/0077978 A1
(43) Pub. Date: Mar. 27, 2008

(54) ABSTRACT PASSWORD AND INPUT METHOD

(76) Inventors: Rolf Repasi, Sunrise Beach (AU); Simon Clausen, New South Wales (AU)

Correspondence Address: BRINKS HOFER GILSON & LIONE, P.O. BOX 10395, CHICAGO, IL, 60610, US

(21) Appl. No.: 11/860,153

(22) Filed: Sep. 24, 2007

Related U.S. Application Data
(60) Provisional application No. 60/847,324, filed on Sep. 26, 2006.

(51) Int. Cl. G06F 21/00

(52) U.S. Cl. 726/5

(57) ABSTRACT

A method/system/program for allowing user input of a password. The method includes the steps of, in a processing system, presenting password elements to a user, allowing a user to select certain password elements and submitting the password. Checking can be performed to see if a password criteria has been satisfied prior to submission. The password can also be converted to a binary format, after which processing of the converted password can occur. The password elements are represented by objects that are non-alphanumeric characters, for example various values or aspects, such as shapes, characters, styles, filling or shading, and/or colouring.

This application claims the benefit of priority from U.S. Provisional Patent Application No. 60/847,324 filed Sep. 26, 2006, and is incorporated by referenced.

### TECHNICAL FIELD

The present invention generally relates to the field of computing and malicious software or software threats, such as for example a keylogger or a computer virus, and more particularly to a method, system, computer readable medium of instructions and/or computer program product for allowing a user to input a password in a more secure manner.

### BACKGROUND ART

Users of computer software, networks and other computer-implemented services often select “easy-to-guess” passwords as logon protection, for example to protect various accounts or allow access to data or software. Presently, it is known for back-end software to “salt” user input, either before or after hashing of the user input. If the user input is easy to guess, or can be relatively easily obtained or determined, for example via a brute force attack, then a user's identity, account, data, access privileges, etc., may be compromised.

Additionally, currently known password input methods usually involve a keypad such as a computer keyboard or a stylus (for example in the case of Personal Digital Assistants (PDAs)), which can allow passwords to be trivially intercepted using keylogging software and/or keylogging hardware.

Currently known methods/systems typically rely on imposing a password policy, where a user is not allowed to select certain “weak” passwords. If a weak password is attempted to be submitted, the user can be forced to re-enter a different password or a service may generate a password for the user which adheres to the password policy.

A password policy may include requirements such as:

The password must be of a certain minimum length, for example eight characters;

The password must contain lower case characters;

The password must contain upper case characters; length; H(x) is relatively easy to compute for any given x; H(x) is one-way; and H(x) is collision-free.

A hash function H is said to be one-way if it is hard to invert, meaning that for a given h, it is computationally infeasible to find some input x such that H(x)=h. If, given a message x, it is computationally infeasible to find a message y not equal to x such that H(x)=H(y), then H is said to be a weakly collision-free hash function. A strongly collision-free hash function H is one for which it is computationally infeasible to find any two messages x and y such that H(x)=H(y).

“Salt” generally refers to a small bit of near-random data inserted where too much regularity would be undesirable. For example, the Unix crypt (3) manual page mentions that “the salt string is used to perturb the DES algorithm in one of 4096 different ways.”

“Entropy” is a measure of the disorder or randomness in a closed system. The entropy of a system increases with time and goes from a state of order (low entropy) to a state of disorder (high entropy). The entropy of a system can be considered to be related to the amount of information the system contains. A highly ordered system can be described using fewer bits of information than a disordered system. For example, a string containing one million “0”s can be described using run-length encoding as [(“0”, 1000000)], whereas a string of random symbols (e.g. bits, or characters) is much harder, if not impossible, to compress in a similar way.

A brute force attack method attempts to break a cipher (that is, to decrypt a specific encrypted text) by trying every possible key. The quicker the brute force attack, the weaker the cipher. The feasibility of a brute force attack depends on the key length of the cipher, and on the amount of computational power available for use by the brute force attack.

ASCII (American Standard Code for Information Interchange) refers to a code for information exchange between computers made by different companies. A string of 7 binary digits represents each character and is used in most microcomputers.

There are currently a number of techniques which can be used to detect malware in a processing system, such as a keylogger that may be attempting to intercept password input by a user. One technique includes using database driven malware techniques which detect known malware. In this technique, a database is used which generally includes a signature indicative of a particular type of malware. However, this technique suffers from a number of disadvantages. Generating and comparing signatures for each entity in a processing system to the database can be a highly process-intensive task. Other applications can be substantially hampered or can even malfunction during this period of time when the detection process is performed. Furthermore, this technique can only detect known malware. If there is no signature in the database for a new type of malware, malicious activity could be performed without detection of the new type of malware.

Although certain anti-malware software seeks to detect the presence of keyloggers or the like, new types of malware are continually emerging which can expose the vulnerability of user selected passwords. It would be preferable to provide an improved means of allowing user input of a password to avoid such malware.

In a networked information or data communications system, a user has access to one or more terminals which are capable of requesting and/or receiving information or data from local or remote information sources. In such a communications system, a terminal may be a type of processing system, computer or computerised device, personal computer (PC), mobile, cellular or satellite telephone, mobile data terminal, portable computer, Personal Digital Assistant (PDA), pager, thin client, or any other similar type of digital electronic device. The capability of such a terminal to request and/or receive information or data can be provided by software, hardware and/or firmware. A terminal may include or be associated with other devices, for example a local data storage device such as a hard disk drive or solid state drive.

An information source can include a server, or any type of terminal, that may be associated with one or more storage devices that are able to store information or data, for example in one or more databases residing on a storage device. The exchange of information (ie. the request and/or receipt of information or data) between a terminal and an information source, or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

There is a need for a method, system, computer program product and/or computer readable medium of instructions which addresses or at least ameliorates one or more problems inherent in the prior art.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### BRIEF DESCRIPTION OF FIGURES

The present invention should become apparent from the following description, which is given by way of example only, of a preferred but non-limiting embodiment thereof, described in connection with the accompanying figures.

FIG. 1 illustrates a functional block diagram of an example processing system that can be utilized to embody or give effect to a particular embodiment;

FIG. 2 illustrates an example overview system for user input of a password;

FIG. 3 illustrates a flow diagram of an example method for user input of a password; and

FIG. 4 illustrates an example user interface.

### DISCLOSURE OF INVENTION

According to a first broad form, there is provided a method of allowing user input of a password. Users may select and enter one or more passwords using an abstract representation of data, rather than inputting ASCII characters (for example user selection can be by using a keyboard, either hardware or software implemented such as a touch screen, a mouse, a pointer-device or a stylus). The method seeks to provide increased entropy, relative to ASCII input, to be associated with the input password, thus making it more difficult, or preferably infeasible, to use a brute force attack to determine the password.

In a particular example embodiment, there is provided a method of allowing a user to input a password including the steps of presenting password elements to the user, receiving selected password elements from the user, and submitting the password. According to further optional aspects, the method may include converting the password to binary format, and then performing processing on the converted password.

In a particular, but non-limiting, form the password is not submitted until at least one password criteria is satisfied.

According to a further example form, each password element is selected from one or more password arrays, each array including a selection of one or more objects, where an object is, for example, a value, a shape, or an aspect of a value or a shape. Other types of object are also possible and are hereinafter discussed.

Optionally, an object (i.e. value, shape or aspect) may be a shape such as, for example: a square, a triangle, a cross, a circle, a hexagon, a diamond, a left arrow, a right arrow, an up arrow, a down arrow, etc.

Optionally, an object (i.e. value, shape or aspect) may be a style, such as, for example: filled, border only, striped, chequered, etc.

Optionally, an object (i.e. value, shape or aspect) may be a colour, such as, for example: red, green, blue, black, white, grey, pink, purple, orange, yellow, aqua, etc.

According to further broad forms, there is provided a system and a computer program product for embodying the aforementioned methods.

### MODES FOR CARRYING OUT THE INVENTION

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

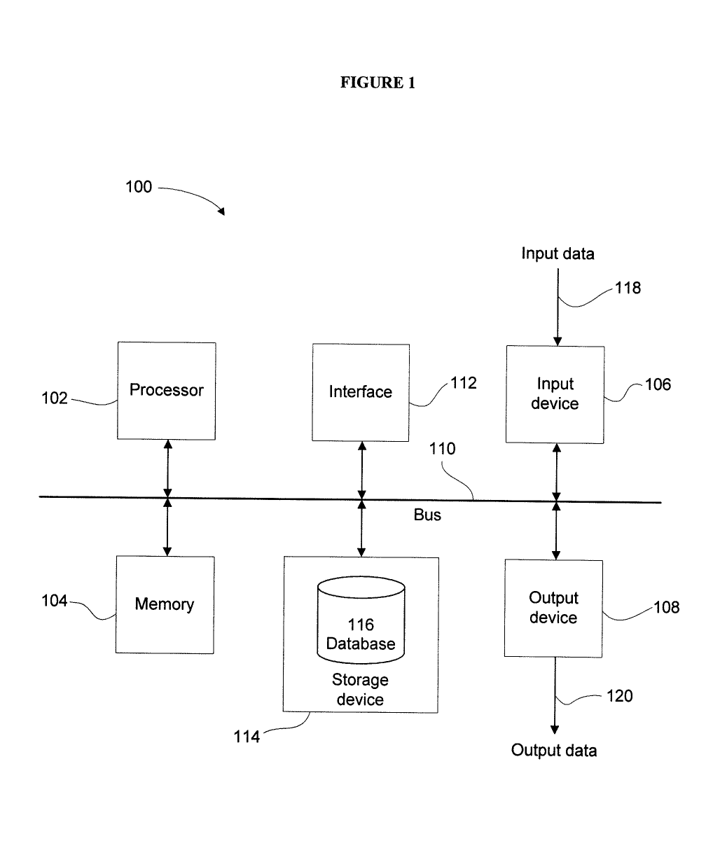

A particular embodiment of the present invention can be realised using a processing system, an example of which is shown in FIG. 1. In particular, the processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In a particular embodiment, input data 118 can be a password and output data 120 can be a converted or processed password transmitted to a remote processing system.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. More than one input device 106 and/or output device 108 can be provided. It should be appreciated that the processing system 100 may be any form of terminal, server, specialised hardware, or the like.

The processing system 100 may be a part of a networked communications system. Processing system 100 could connect to a network, for example the Internet or a WAN. Input data 118 and output data 120 could be received from or communicated to other devices, such as a server, via the network. The network may form part of, or be connected to, the Internet, and may be or form part of other communication networks, such as LAN, WAN, ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

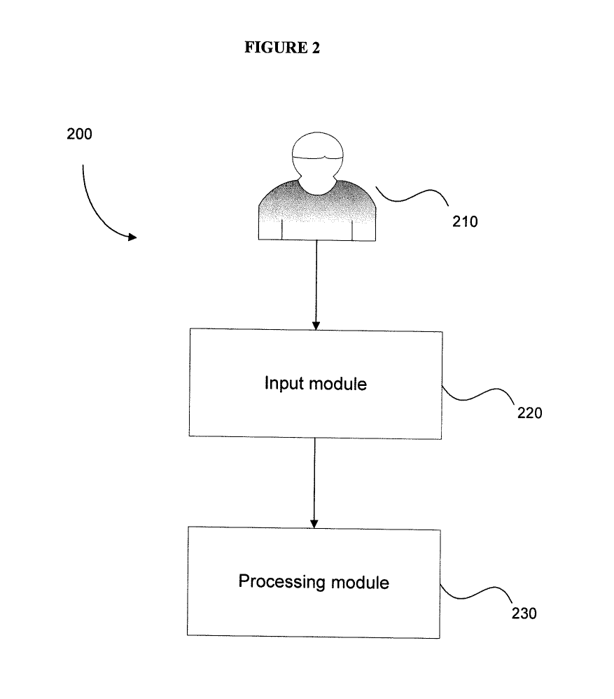

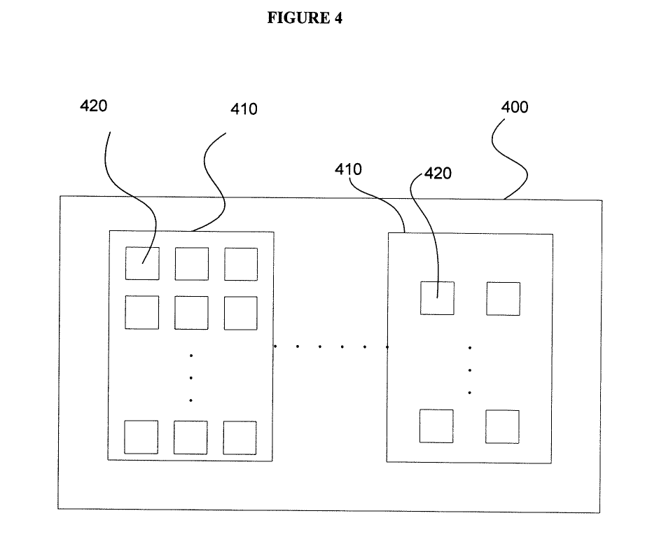

Referring to FIG. 2, there is illustrated a system 200 for allowing user input of a password. User 210 interacts with input module 220 which provides a user interface 400 (refer to FIG. 4). Input module 220 receives password elements selected by user 210 via user interface 400. Input module 220 passes password elements to processing module 230 for processing and/or conversion of data. Processing module 230 may check if certain password criteria, for example a minimum length of password elements, has been satisfied. Processing module 230 may also convert a submitted password to a binary format. The converted password in binary format can then be further processed, for example by salting and/or application of a hash function.

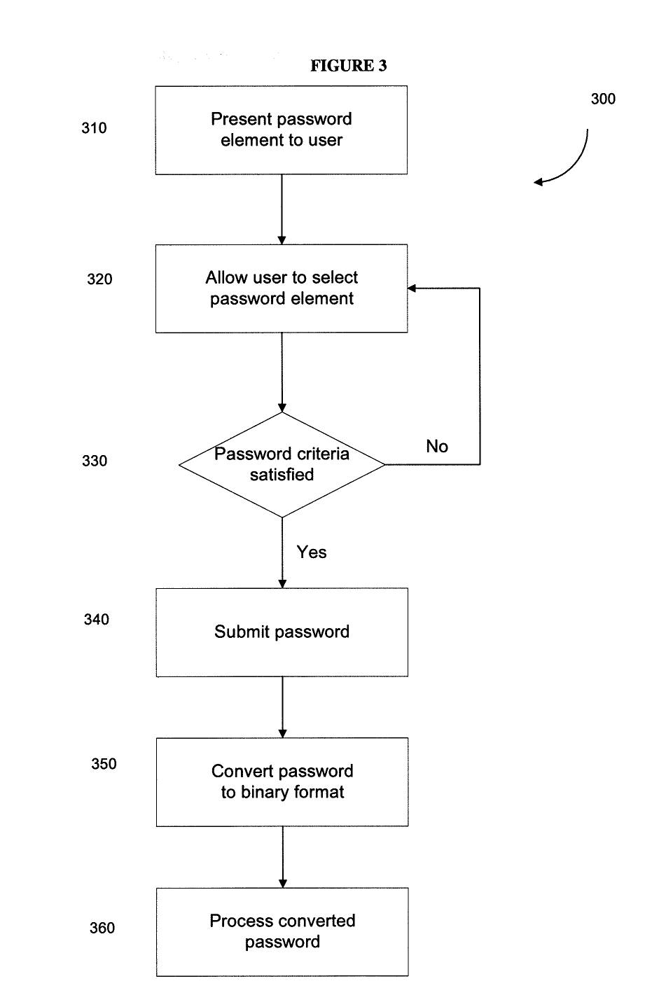

Referring to FIG. 3, there is illustrated a method 300 of allowing or facilitating user input of a password. At step 310, a user is presented with password elements, preferably via user interface 400. At step 320, the user is allowed to select password elements, for example using user interface 400. Other types of user interface can be utilised. The user proceeds to select desired password elements to form the user's preferred password. At step 330, a password criteria checking module or algorithm may be used to see if one or more password criteria is satisfied. If password criteria is satisfied at step 330 the method can proceed to step 340. If password criteria is not satisfied at step 330 the user can be prompted to input or change password elements at step 320.

At step 340, the user inputted password can be submitted. Submission may be to a local terminal or a remote terminal, for example user interface 400 may be presented on a web-page and the password submitted to a remote server. Password elements may be presented on a web-page and the password may be submitted to an application, either running on a local terminal or a remote terminal. At step 350, the password is converted to binary format. The conversion at step 350 may occur locally at a terminal or at a remote server. At step 360, the converted password is processed, which, as before, can occur either at a local terminal or a remote server. Processing of the converted password can include salting and/or application of a hash function to the binary format password.

Referring to FIG. 4, there is illustrated a representative user interface 400. User interface 400 may be presented to a user by a variety of means, for example as part of a web-page, as a pop-up box, as part of a software application, as a stand alone application, and/or as an applet. User interface 400 preferably includes one or more panels 410 that can be provided in a variety of configurations. Each panel 410 includes one or more password elements 420 which likewise can be provided in a variety of configurations. A user can select password elements 420 from one or more panels 410. For example, a user might select an arrangement of password elements from a first panel, a second panel and a third panel. The number and configuration of panels and password elements can be varied. A wide variety of configurations is possible.

For example, user interface 400 may allow a user to be able to select each password element 420 from an array of password elements provided as a combination of objects, i.e. a combination of values, shapes and/or aspects. For example, the array of password elements, grouped in panels, could be presented to the user based on the following table.

TABLE 1
Array of Password Elements

| Shape | Style | Colour |
|---|---|---|
| 01. Square | 01. Filled | 01. Red |
| 02. Triangle | 02. Border only | 02. Green |
| 03. Cross | 03. Striped | 03. Blue |
| 04. Circle | 04. Chequered | 04. Black |
| 05. Hexagon | | 05. White |
| 06. Diamond | | 06. Grey |
| 07. Left arrow | | 07. Pink |
| 08. Right arrow | | 08. Purple |
| 09. Up arrow | | 09. Orange |
| 10. Down arrow | | 10. Yellow |
| | | 11. Aqua |

Table 1 allows for a selection of 444 (10×4×11) unique values for each member of the password array. In practice, this number of selections may be considered too high and thus certain values may be excluded to limit the number of combinations to 255. Each password element could be represented by various icons, images, indicia, characteristics of indicia, digital photos, animations, audio or video clips.

In a particular embodiment, the method of the present invention provides a user interface for password input by a user. Each password element is represented by an abstract indication, for example various indicia or icons, colours, shapes, textures, etc., and combinations thereof. Preferably, the user is provided with a greater number of password elements than the standard number of ASCII characters (128 different bit patterns).

It should be noted that a password element could be an ASCII character. For example, one of the panels could present ASCII characters to the user for use as password elements. In this example, the user could select a standard ASCII based password in combination with one or more objects from another panel, for example the object could be a colour or style of the ASCII based password, or an image to be associated with the ASCII based password. Thus, selection of password elements to form a password can involve a user selecting ASCII characters (such as standard alpha-numerals) in combination with selection of one or more objects. ASCII characters could be selected from a panel as for the selection of objects, or entered via a keyboard.

The user interface may include one or more panels displaying groupings of password elements (i.e. input elements). Password elements may be displayed in a pseudo-random fashion, resulting in password elements being displayed at a different location, or different relative location, each time a user loads the user interface. Password elements may automatically scroll and pause when the user “hovers” the user's curser/mouse over a particular password element. Additionally or alternatively, password elements may scroll or animate when a user “hovers” the user's curser/mouse over a particular section of a panel. In another embodiment, a panel can be provided with a group of objects, such as shapes, where the ordering or positioning of the objects is constantly or periodically changing, for example by being animated or moved. Movement of objects could be set at any desired speed for user visibility or usability, and movement could be in any direction, for example horizontal or vertical. A user could select an object as desired using a pointing device. In another form, hovering or positioning a pointer, e.g. a mouse pointer, over a moving object could cause the movement of the object to be slowed, and eventually cause user selection of the object without the user having to click on the object (for example after hovering over a stopped object for one second).

Similar password policies as those discussed in the prior art may still be applied to password input with certain modifications, for example the entered password could still be required to be of a minimum number of password elements, and/or each password element might be required to be unique.

Preferably, once the user has selected a password, the submitted password is converted to binary format. Conversion can be performed by mapping each possible input element to a byte representation, for example up to the number 255. The converted password can then be processed in a similar manner as is presently known, for example the converted password can be salted then hashed to provide a unique value even when two users have selected the same password.

The following pseudocode illustrates how a computer program product can be structured to provide the method of allowing user input of a password.

```
Function Initialize( )
Begin
    Call build_input_table(table);
    Call display_input_panel;
End
Function Apply(user_input)
Begin
    Password : array of byte;
    With each input_element in user_input Do Begin
        Id = table.getId(input_element);
        Password+= Id;
    End
    If NOT verify_policies(Password) Then Begin
        Call Alert_User;
        Exit;
    End
    Call add_salt(Password);
    Data = Hash(Password);
    Call transmit(Data);
End
```

The invention may be embodied as a computer readable medium of instructions and/or a computer program product, e.g. software. Such software can be implemented separately or in combination with known software packages and/or online services. Such software can be used to provide added password security by enabling input of passwords consisting of non-alphanumeric indicia, i.e. abstract “characters” or “aspects” of characters. An embodiment may run on the Windows® operating system, however it should be realised that various embodiments can be applied to any operating system on any type of terminal.

Example applications can include: web-site logon, for example internet banking; terminal logon, for example to extend existing logon mechanisms such as the Windows® logon screen; and software registration/activation codes, for example to activate a software product after purchase.

Thus, there has been provided a means for allowing user input of a password.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

The present invention may take the form of an entirely hardware embodiment, an entirely software embodiment, firmware, or an embodiment combining software and hardware aspects.

1. A method of allowing a user to input a password, the method including at least one processing system performing the steps of:
presenting password elements to the user, at least one password element represented by an object;
receiving user selected password elements to form a password; and, submitting the password.

2. The method as claimed in claim 1, wherein the object is selected from a panel, the panel including a plurality of different objects.

3. The method as claimed in claim 1, wherein the object is a shape.

4. The method as claimed in claim 1, wherein the object is a style.

5. The method as claimed in claim 1, wherein the object is a colour.

6. The method as claimed in claim 1, wherein the object is selected from the group consisting of an icon, an indicia, an image, a characteristic of indicia, a texture, a digital photo, an animation, an audio clip, and a video clip.

7. The method as claimed in claim 1, wherein one or more objects are presented in one or more panels.

8. The method as claimed in claim 1, wherein the user selects at least a first password element from a first panel, and selects at least a second password element from a second panel.

9. The method as claimed in claim 8, wherein the location of the first password element in the first panel and the location of the second password element in the second panel changes each time when presented to the user.

10. The method as claimed in claim 8, wherein the user further selects at least a third password element from a third panel.

11. The method as claimed in claim 1, wherein at least one of the password elements is an alpha-numeric character.

12. The method as claimed in claim 1, further including converting the password to binary format.

13. The method as claimed in claim 12, further including salting the binary format password.

14. The method as claimed in claim 12, further including applying a hash function to binary format password.

15. The method as claimed in claim 1, wherein at least one password criteria must be satisfied before the password is submitted.

16. The method as claimed in claim 2, wherein the ordering or positioning of the different objects constantly or periodically changes.

17. A system to allow a user to input a password, the system including at least one processor configured to:
present password elements to the user, at least one password element represented by an object;
receive user selected password elements to form a password; and,
submit the password.

18. A computer program product to allow a user to input a password, the computer program product configured to:
present password elements to the user, at least one password element represented by an object;
receive user selected password elements to form a password; and,
submit the password.

19. The computer program product as claimed in claim 18, including an input module providing a user interface presenting one or more panels including one or more objects.

20. The computer program product as claimed in claim 19, wherein the user interface is a web-page, a pop-up box, part of a software application, a stand alone application, or an applet.

21. The computer program product as claimed in claim 18, including a processing module to convert the received password to binary format and check at least one password criteria has been satisfied.
